(19) United States
(12) Patent Application Publication
(10) Pub. No.: US 2013/0010667 A1
(43) Pub. Date: Jan. 10, 2013

(54) APPARATUS AND METHOD FOR PROVIDING MULTICAST/ BROADCAST SERVICE IN MOBILE COMMUNICATION SYSTEM

(76) Inventors: Dong-Chan LEE, Seongnam-si (KR); Jung-Suk LEE, Seongnam-si (KR); Hee-Joon PARK, Gwangmyeong-si (KR); Ho-Sung YOON, Suwon-si (KR); Chan-Kyu KANG, Seoul (KR); Han-Jong JANG, Uiwang-si (KR); Seong-Ung YUN, Seongnam-si (KR); Hak-Yong LEE, Seongnam-si (KR); Kyoung-Jae LEE, Seoul (KR); Sang-Rok KIM, Sasang-gu (KR)

(21) Appl. No.: 13/542,770

(22) Filed: Jul. 6, 2012

(30) Foreign Application Priority Data
Jul. 6, 2011 (KR) 10-2011-0066912

(51) Int. Cl. H04W 4/06

(52) U.S. Cl. 370/312

(57) ABSTRACT

An apparatus and method for providing a multicast/broadcast service in a mobile communication system. Upon detecting an occurrence of a multicast data packet, an Internet Protocol (IP) terminal converts the multicast data packet into an alternative multicast data packet, and transmits the alternative multicast data packet to a femto Node B. Upon detecting an occurrence of a broadcast data packet, the IP terminal converts the broadcast data packet into an alternative broadcast data packet, and transmits the alternative broadcast data packet to the femto Node B.

### PRIORITY

This application claims the benefit under 35 U.S.C. §119(a) of a Korean Patent Application filed in the Korean Intellectual Property Office on Jul. 6, 2011 and assigned Serial No. 10-2011-0066912, the entire disclosure of which is incorporated herein by reference.

### BACKGROUND OF THE INVENTION

1. Field of the Invention

The present invention relates generally to an apparatus and method for providing a multicast/broadcast service in a mobile communication system. More particularly, the present invention relates to an apparatus and method for providing a multicast/broadcast service in a mobile communication system including a femto Node B(s).

2. Description of the Related Art

A typical example of a mobile communication system may include a Wideband Code Division Multiple Access (WCMDA) communication system, and the WCDMA communication system has been evolved to provide various high-speed large-capacity services to User Equipments (UEs). Especially, in the WCDMA communication system, in order to increase an entire system capacity and improve a service quality, it is very important to provide a service in a shaded area(s), which contributes to an expansion of a service area of a Node B and an increase in capacity of the Node B.

Therefore, in the WCDMA communication system, various schemes of providing a service in a shaded area have been proposed, typical examples of which include a service scheme based on a relay or repeater using an interface with a macro Node B, and a service scheme based on a femto Node B using an interface with a Core Network (CN). The femto Node B, which is the smallest Node B from among the Node Bs that have been proposed up to now, provides a communication service to a small number of UEs located in a femto cell area, which is a small-sized communication area, such as an office, a residence and a building, which are independent of the typical Node B, i.e., a macro Node B. In other words, the femto Node B not only can provide a communication service in a shaded area but also can reduce a load of the macro Node B. Therefore, the femto Node B may contribute to an increase in service capacity of service providers, unlike the relay that simply shares a capacity of the macro Node B.

Further, in the WCDMA communication system, various schemes for providing a multicast/broadcast service have been proposed. With the use of the proposed multicast/broadcast service schemes, multicast/broadcast data packets can be transmitted through a downlink. In other words, the femto Node B may transmit multicast/broadcast data packets to UEs.

However, in the proposed multicast/broadcast service schemes, an uplink, unlike the downlink, may not carry or transmit multicast/broadcast data packets. In other words, it is not possible for the UEs to transmit multicast/broadcast data packets to the femto Node B, because the WCDMA communication system does not allow the UEs to generate multicast groups independently.

Accordingly, there is a need for a new multicast/broadcast service method that makes it possible to transmit multicast/broadcast data packets through an uplink in a WCDAM communication system.

### SUMMARY OF THE INVENTION

An aspect of an exemplary embodiment of the present invention is to provide an apparatus and method for providing a multicast/broadcast service in a mobile communication system.

Another aspect of exemplary embodiments of the present invention is to provide a multicast/broadcast service providing apparatus and method for enabling transmission of uplink multicast/broadcast data packets in a mobile communication system.

Further another aspect of exemplary embodiments of the present invention is to provide an apparatus and method for providing a multicast/broadcast service in a mobile communication system supporting an IP Local network IP Access (LIPA) scheme.

Still another aspect of exemplary embodiments of the present invention is to provide an apparatus and method for providing a multicast/broadcast service without a change in protocols in a mobile communication system including a femto Node B.

In accordance with one aspect of the present invention, there is provided an Internet Protocol (IP) terminal in a mobile communication system. The IP terminal includes a control unit for converting a multicast data packet to an alternative multicast data packet upon detecting an occurrence of the multicast data packet, and converting a broadcast data packet to an alternative broadcast data packet upon detecting an occurrence of the broadcast data packet; and a transmission unit for transmitting the alternative multicast data packet to a femto Node B and transmitting the alternative broadcast data packet to the femto Node B.

In accordance with another aspect of the present invention, there is provided a femto Node B in a mobile communication system. The femto Node B includes a reception unit for receiving an alternative multicast data packet from an Internet Protocol (IP) terminal, and receiving an alternative broadcast data packet from the IP terminal; a control unit for converting the alternative multicast data packet to a multicast data packet, and converting the alternative broadcast data packet to a broadcast data packet; and a transmission unit for transmitting the multicast data packet to IP terminals included in a corresponding multicast group, and transmitting the broadcast data packet to all of IP terminals connected to the femto Node B.

In accordance with another aspect of the present invention, there is provided a method for providing a multicast/broadcast service by an Internet Protocol (IP) terminal in a mobile communication system. The method includes, upon detecting an occurrence of a multicast data packet, converting the multicast data packet to an alternative multicast data packet, and transmitting the alternative multicast data packet to a femto Node B; and upon detecting an occurrence of a broadcast data packet, converting the broadcast data packet to an alternative broadcast data packet, and transmitting the alternative broadcast data packet to the femto Node B.

In accordance with another aspect of the present invention, there is provided a method for providing a multicast/broadcast service by a femto Node B in a mobile communication system. The method includes, upon receiving an alternative multicast data packet from an Internet Protocol (IP) terminal, converting the alternative multicast data packet to a multicast data packet, and transmitting the multicast data packet to IP terminals included in a corresponding multicast group; and upon receiving an alternative broadcast data packet from the IP terminal, converting the alternative broadcast data packet to a broadcast data packet, and transmitting the broadcast data packet to all of IP terminals connected to the femto Node B.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 schematically illustrates a Wideband Code Division Multiple Access (WCMDA) communication system in accordance with an exemplary embodiment of the present invention;

FIG. 2 illustrates a format of an uplink alternative multicast data packet transmitted from UEs to a femto Node B in a WCDMA communication system according to an embodiment of the present invention;

FIG. 3 illustrates a format of an uplink alternative broadcast data packet transmitted from UEs to a femto Node B in a WCDMA communication system according to an embodiment of the present invention;

FIG. 4 illustrates a format of a downlink multicast data packet transmitted from a femto Node B to UEs in a WCDMA communication system according to an embodiment of the present invention;

FIG. 5 illustrates a format of a downlink broadcast data packet transmitted from a femto Node B to UEs in a WCDMA communication system according to an embodiment of the present invention;

FIG. 6 is a flowchart schematically illustrating an operation of an UE in a WCDMA communication system according to an exemplary embodiment of the present invention;

FIG. 7 is a flowchart schematically illustrating an operation of a femto Node B in a WCDMA communication system according to an exemplary embodiment of the present invention;

FIG. 8 is a block diagram schematically illustrating an internal structure of a femto Node B in a WCDMA communication system according to an embodiment of the present invention; and

FIG. 9 is a block diagram schematically illustrating an internal structure of an UE in a WCDMA communication system according to an embodiment of the present invention.

Throughout the drawings, the same drawing reference numerals will be understood to refer to the same elements, features and structures.

### DETAILED DESCRIPTION OF EXEMPLARY EMBODIMENTS

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

An exemplary embodiment of the present invention proposes an apparatus and method for providing a multicast/broadcast service in a mobile communication system.

Another exemplary embodiment of the present invention proposes a multicast/broadcast service providing apparatus and method for enabling transmission of multicast/broadcast data packets from a terminal to which an Internet Protocol (IP) address is allocated (hereinafter referred as an IP terminal), to a femto Node B in a mobile communication system.

Further another exemplary embodiment of the present invention proposes an apparatus and method for providing a multicast/broadcast service in a mobile communication system supporting an IP Local network IP Access (LIPA) scheme.

Exemplary embodiments of the present invention will be described below with reference to a mobile communication system, for example, a Wideband Code Division Multiple Access (WCDMA) communication system. However, it will be understood by those of ordinary skill in the art that the mobile communication system may be any one of a Code Division Multiple Access (CDMA) communication system, a 3rd Generation Partnership Project Long-Term Evolution (3GPP LTE) communication system, an Institute of Electrical and Electronics Engineers (IEEE) 802.16 communication system, and Mobile Worldwide Interoperability for Microwave Access (Mobile WiMAX) communication system as well as the WCDMA communication system. Further, in exemplary embodiments of the present invention, it is assumed that an IP terminal is a User Equipment (UE). However, it will be understood by those of ordinary skill in the art that the IP terminal may be one of any terminals to which IP addresses are allocated, as well as the UE.

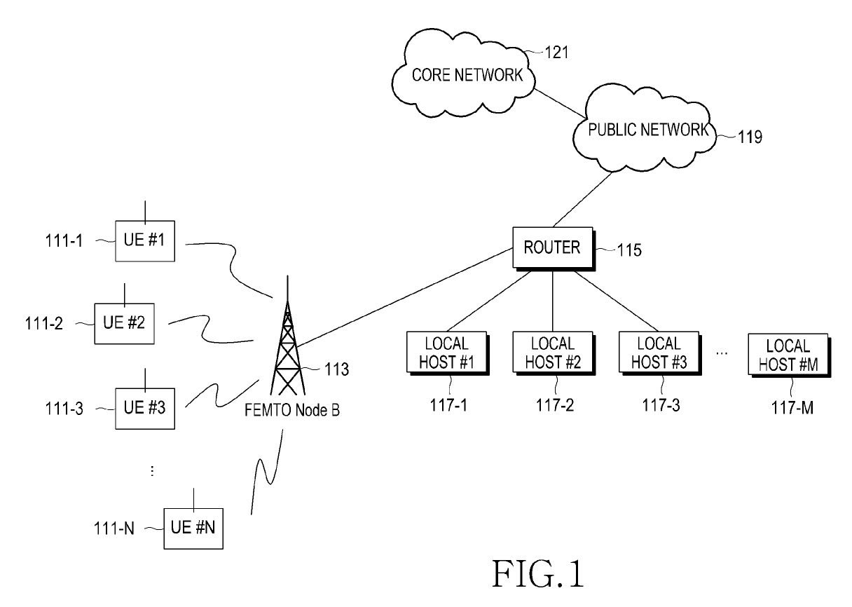

FIG. 1 schematically illustrates a WCMDA communication system in accordance with an exemplary embodiment of the present invention.

Referring to FIG. 1, the WCDMA communication system includes a plurality of UEs, for example, N UEs, i.e., an UE#1 111-1, an UE#2 111-2, an UE#3 111-3, . . . , and an UE#N 111-N, a femto Node B 113, a router 115, a plurality of local hosts, for example, M local hosts, i.e., a local host #1 117-1, a local host #2 117-2, a local host #3 117-3, . . . , and a local host #M 117-M, a public network 119, and a core network 121.

In FIG. 1, the public network 119 is connected to one router, i.e., the router 115, and one router is connected to one femto Node B, i.e., the femto Node B 113. However, it will be understood by those of ordinary skill in the art that the number of routers connected to one public network and the number of femto Node Bs connected to one router is not limited.

Further, it is assumed that the WCDMA communication system, as illustrated in FIG. 1, supports an LIPA scheme. In FIG. 1, the UEs and the femto Node B 113 are distinguished from the local hosts. However, if the WCDMA communication system uses a LIPA scheme, the UEs and the femto Node B 113 are also decided as local hosts in view of the router 115.

In the WCDMA communication system, if the various schemes for providing a multicast/broadcast service, which have been proposed up to now, are used, it is impossible that multicast/broadcast data packets are transmitted through an uplink unlike a downlink. In other words, it is impossible that the UEs transmit multicast/broadcast data packets to a femto Node B 113.

However, exemplary embodiments of the present invention propose a method of providing a multicast/broadcast service thereby transmitting uplink multicast/broadcast data packets. In other words, if a method of providing a multicast/broadcast service, according to exemplary embodiments of the present invention, is used, it is possible that UEs transmit uplink multicast/broadcast data packets to a femto Node B.

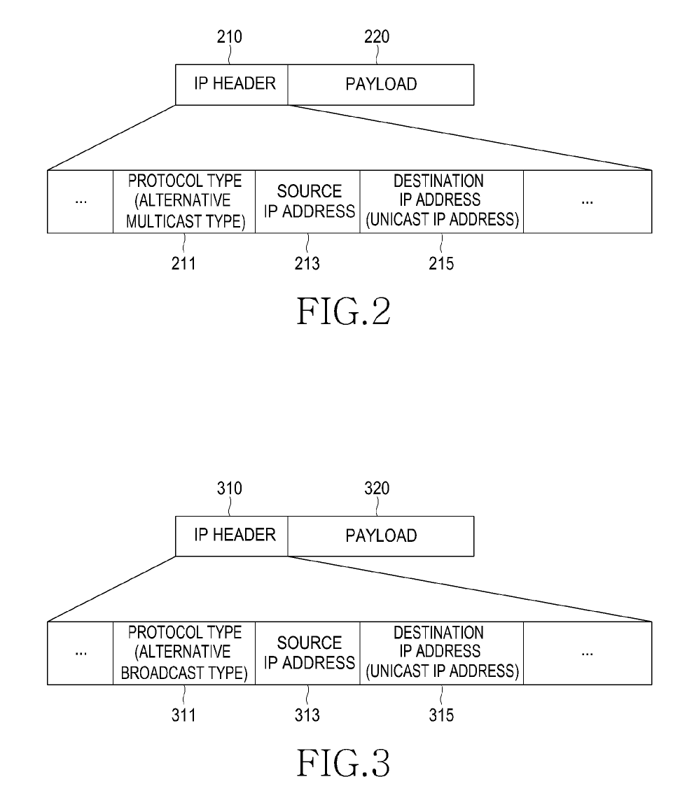

FIG. 2 illustrates a format of an uplink alternative multicast data packet transmitted from UEs to a femto Node B in a WCDMA communication system according to an embodiment of the present invention.

Referring to FIG. 2, the uplink alternative multicast data packet includes an IP header field 210, and a payload field 220. The IP header field 210 includes a protocol type field 211, a source IP address field 213, and a destination IP address field 215.

The protocol type field 211 represents a protocol type of the uplink alternative multicast data packet, and a filed value of the protocol type field 211 is set as an alternative multicast type because a corresponding data packet is a multicast data packet. The alternative multicast type is set as a protocol type unused currently between a femto Node and UEs in a WCDMA communication system. It is assumed that the alternative multicast type is predetermined between the femto Node and the UEs.

The source IP address field 213 represents an IP address of a source transmitting the uplink alternative multicast data packet, and a filed value of the source IP address field 213 is set as an IP address of an UE transmitting the uplink alternative multicast data packet.

The destination IP address field 215 represents an IP address of a destination receiving the uplink alternative multicast data packet, and a filed value of the destination IP address field 215 is set as an unicast IP address.

If a femto Node B receives an uplink alternative multicast data packet having a format as described in FIG. 2, the femto Node B may transmit the uplink alternative multicast data packet to UEs included in a corresponding multicast group because the field value of the protocol type field 211 represents the alternative multicast type. For brevity, descriptions of generation of the multicast group and UEs included on the multicast group may be omitted.

FIG. 3 illustrates a format of an uplink alternative broadcast data packet transmitted from UEs to a femto Node B in a WCDMA communication system according to an embodiment of the present invention.

Referring to FIG. 3, the uplink alternative broadcast data packet includes an IP header field 310, and a payload field 320. The IP header field 310 includes a protocol type field 311, a source IP address field 313, and a destination IP address field 315.

The protocol type field 311 represents a protocol type of the uplink alternative broadcast data packet, and a filed value of the protocol type field 311 is set as an alternative broadcast type because a corresponding data packet is a broadcast data packet. The alternative broadcast type is set as a protocol type unused currently between a femto Node and UEs in a WCDMA communication system. It is assumed that the alternative broadcast type is predetermined between the femto Node and the UEs.

The source IP address field 313 represents an IP address of a source transmitting the uplink alternative broadcast data packet, and a filed value of the source IP address field 313 is set as an IP address of an UE transmitting the uplink alternative broadcast data packet.

The destination IP address field 315 represents an IP address of a destination receiving the uplink alternative broadcast data packet, and a filed value of the destination IP address field 315 is set as an unicast IP address.

If a femto Node B receives an uplink alternative broadcast data packet having a format as described in FIG, 3, the femto Node B may transmit the uplink alternative broadcast data packet to all of UEs connected to femto Node B because the field value of the protocol type field 311 represents the alternative broadcast type.

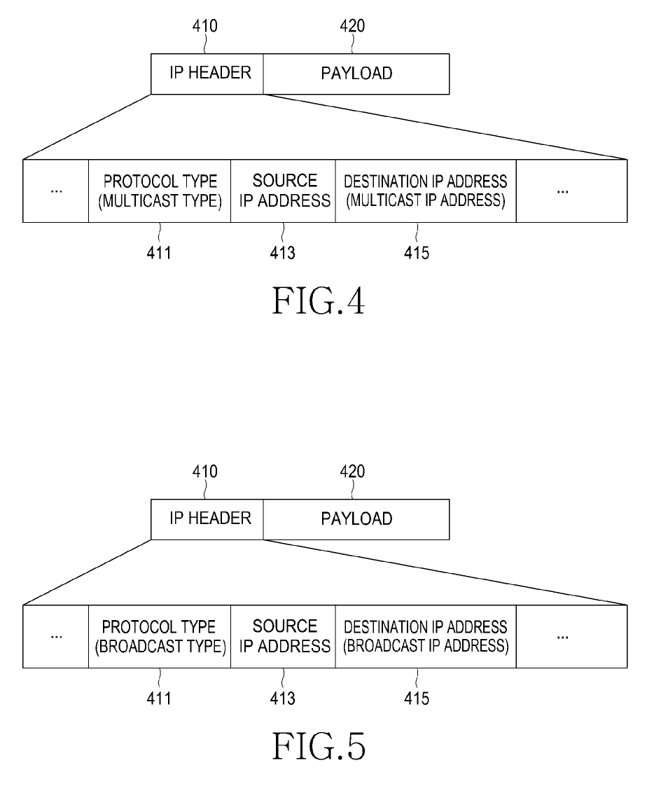

FIG. 4 illustrates a format of a downlink multicast data packet transmitted from a femto Node B to UEs in a WCDMA communication system according to an embodiment of the present invention.

Prior to a description of FIG. 4, if a femto Node B receives an uplink alternative multicast data packet with a format as described in FIG. 2, the femto Node B should transmit the uplink alternative multicast data packet to UEs included in a corresponding multicast group as a field value of the protocol type field 211 represents an alternative multicast type. So, the femto Node B transmits the uplink alternative multicast data packet received from an UE to the UEs included in the corresponding multicast group using the downlink multicast data packet as illustrated in FIG. 4.

Referring to FIG. 4, the downlink multicast data packet includes an IP header field 410, and a payload field 420. The IP header field 410 includes a protocol type field 411, a source IP address field 413, and a destination IP address field 415.

The protocol type field 411 represents a protocol type of the downlink multicast data packet, and a filed value of the protocol type field 411 is set as a multicast type because a corresponding data packet is a multicast data packet. The multicast type is set as a multicast type used generally between a femto Node and UEs in a WCDMA communication system.

The source IP address field 413 represents an IP address of a source transmitting the downlink multicast data packet, and a filed value of the source IP address field 413 is set as an IP address of an UE transmitting the downlink multicast data packet.

The destination IP address field 415 represents an IP address of a destination receiving the downlink multicast data packet, and a filed value of the destination IP address field 415 is set as a multicast IP address. The multicast IP address is predetermined between UEs and a femto Node B.

FIG. 5 illustrates a format of a downlink broadcast data packet transmitted from a femto Node B to UEs in a WCDMA communication system according to an embodiment of the present invention.

Prior to a description of FIG. 5, if a femto Node B receives an uplink alternative broadcast data packet with a format as described in FIG. 3, the femto

Node B transmits the uplink alternative broadcast data packet to all of UEs connected to the femto Node B as a field value of the protocol type field 411 represents a multicast broadcast type. In other words, the femto Node B transmits an uplink alternative broadcast data packet received from a specific UE to all of the UEs connected to the femto Node B using a downlink broadcast data packet as illustrated in FIG. 5.

Referring to FIG. 5, the downlink broadcast data packet includes an IP header field 510, and a payload field 520. The IP header field 510 includes a protocol type field 511, a source IP address field 513, and a destination IP address field 515.

The protocol type field 511 represents a protocol type of the downlink broadcast data packet, and a filed value of the protocol type field 511 is set as a broadcast type because a corresponding data packet is a broadcast data packet. The broadcast type is equal to a broadcast type used generally between a femto Node and UEs in a WCDMA communication system.

The source IP address field 513 represents an IP address of a source transmitting the downlink broadcast data packet, and a filed value of the source IP address field 513 is set as an IP address of an UE transmitting the downlink broadcast data packet.

The destination IP address field 515 represents an IP address of a destination receiving downlink broadcast data packet, and a filed value of the destination IP address field 515 is set as a broadcast IP address.

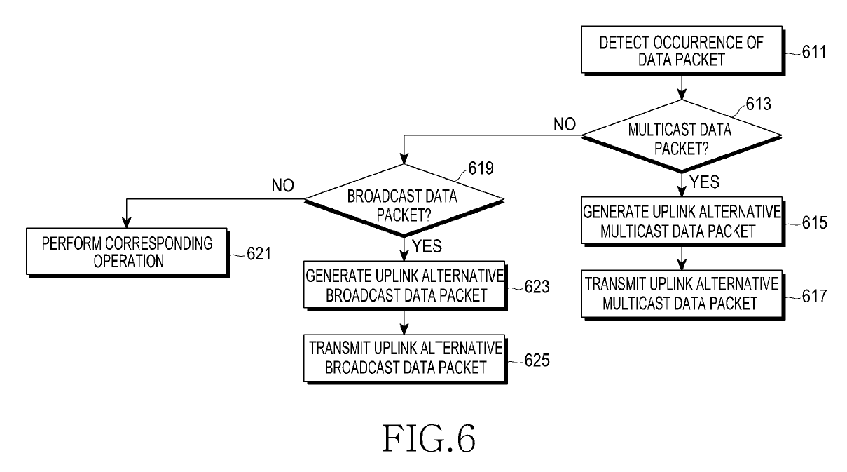

FIG. 6 is a flowchart schematically illustrating an operation of an UE in a WCDMA communication system according to an exemplary embodiment of the present invention.

Referring to FIG. 6, in step 611, the UE detects an occurrence of a data packet. In step 613, the UE determines whether the occurred data packet is a multicast data packet or not. If it is determined in step 613 that the occurred data packet is a multicast data packet, the UE generates an uplink alternative multicast data packet in step 615. As described in FIG. 2, the uplink alternative multicast data packet includes a protocol type field with a field value set as an alternative multicast type, a source IP address field with a field value set as an IP address of the UE, and a destination IP address field with a field value set as an unicast IP address. In step 617, the UE transmits the generated uplink alternative multicast data packet to a femto Node B.

On the other hand, if it is determined in step 613 that the occurred data packet is not the multicast data packet, the UE determines whether the occurred data packet is a broadcast data packet or not in step 619. If it is determined in step 619 that the occurred data packet is not the broadcast data packet, the UE performs a corresponding operation, i.e., an operation of transmitting an unicast data packet in step 621.

On the other hand, if it is determined in step 619 that the occurred data packet is the broadcast data packet, the UE generates an uplink alternative broadcast data packet in step 623. As described in FIG. 3, the uplink alternative broadcast data packet includes a protocol type field with a field value set as an alternative broadcast type, a source IP address field with a field value set as an IP address of the UE, and a destination IP address field with a field value set as an unicast IP address. In step 625, the UE transmits the generated uplink alternative broadcast data packet to a femto Node B.

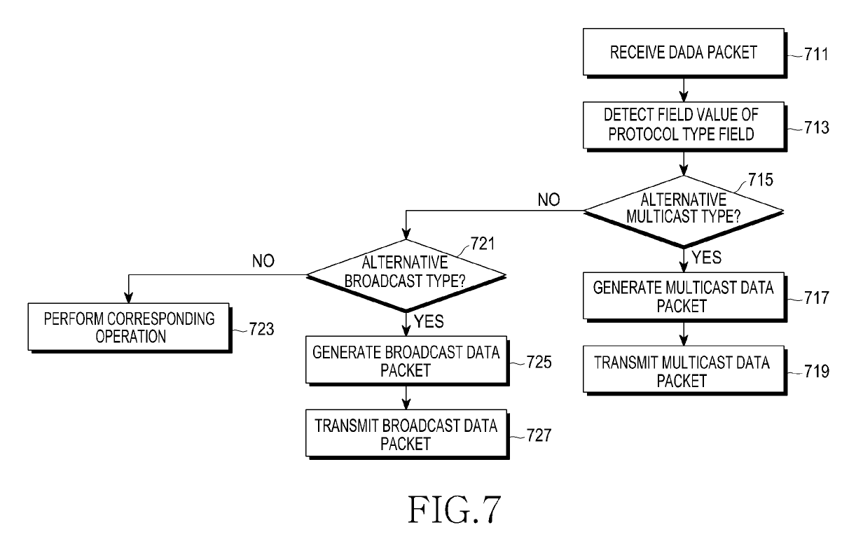

FIG. 7 is a flowchart schematically illustrating an operation of a femto Node B in a WCDMA communication system according to an exemplary embodiment of the present invention.

Referring to FIG. 7, in step 711, the femto Node B receives a dada packet. In step 713, the femto Node B detects a field value of a protocol type field included in the received dada packet. In step 715, the femto Node B determines whether a protocol type of the received dada packet is an alternative multicast type or not. If it is determined in step 715 that the protocol type of the received dada packet is the alternative multicast type, in step 717, the femto Node B generates a multicast data packet corresponding to the received data packet, i.e., the received uplink alternative multicast data packet as the protocol type of the received data packet is the alternative multicast type. As described in FIG. 4, the multicast data packet includes a protocol type field with a field value set as a multicast type, a source IP address field with a field value set as an IP address of an UE, and a destination IP address field with a field value set as a multicast IP address. In step 719, the femto Node B transmits the generated multicast data packet to UEs included in a corresponding multicast group.

On the other hand, if it is determined in step 715 that the protocol type of the received dada packet is not the alternative multicast type, in step 721, the femto Node B determines whether a protocol type of the received dada packet is an alternative broadcast type or not. If it is determined in step 721 that the protocol type of the received dada packet is not the alternative broadcast type, in step 723, the femto Node B performs an operation corresponding to a corresponding protocol type as the protocol type of the received dada packet is not the alternative broadcast type.

On the other hand, if it is determined in step 721 that the protocol type of the received dada packet is the alternative broadcast type, in step 725, the femto Node B generates a broadcast data packet corresponding to the received data packet, i.e., the received uplink alternative broadcast data packet as the protocol type of the received data packet is the alternative broadcast type. As described in FIG. 5, the broadcast data packet includes a protocol type field with a field value set as a broadcast type, a source IP address field with a field value set as an IP address of an UE, and a destination IP address field with a field value set as a broadcast IP address. In step 727, the femto Node B transmits the generated broadcast data packet to all of UEs connected to the femto Node B.

Now, each of the protocol types and the IP addresses as described above will be explained below.

First, a multicast data packet will be explained.

A filed value of a protocol type filed included in the multicast data packet is set as a User Datagram Protocol (UDP), a filed value of a source IP address is set as an IP address of an UE, and a filed value of a destination IP address is set as a multicast IP address included in a class D, for example, 239.255.255.250.

Second, a broadcast data packet will be explained.

A filed value of a protocol type filed included in the broadcast data packet is set as a UDP, a filed value of a source IP address is set as an IP address of an UE, and a filed value of a destination IP address is set as a broadcast IP address, included in a class D, a last value of which is 255, for example, 255.255.255.255 or 10.10.10.255.

Third, an alternative multicast data packet will be explained.

A filed value of a protocol type filed included in the alternative multicast data packet is set as a value unused as a protocol type, for example, 200, a filed value of a source IP address is set as an IP address of an UE, and a filed value of a destination IP address is set as an unicast IP address. The unicast IP address included in the alternative multicast data packet represents a value by subtracting a preset value, for example, 200 from a most significant value of the multicast IP address, for example, 239.

Fourth, an alternative broadcast data packet will be explained.

A filed value of a protocol type filed included in the alternative broadcast data packet is set as a value unused as a protocol type, for example, 201, a filed value of a source IP address is set as an IP address of an UE, and a filed value of a destination IP address is set as an unicast IP address. The unicast IP address included in the alternative broadcast data packet represents a value by subtracting a preset value, for example, 200 from a most significant value of the broadcast IP address, for example, 255.

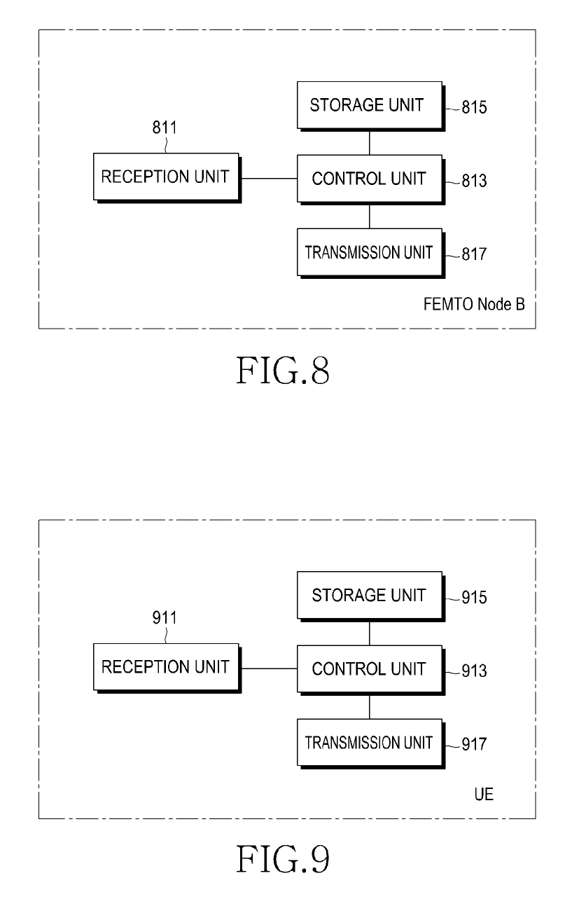

FIG. 8 is a block diagram schematically illustrating an internal structure of a femto Node B in a WCDMA communication system according to an embodiment of the present invention.

Referring to FIG. 8, a femto Node B includes a reception unit 811, a control unit 813, a storage unit 815, and a transmission unit 817. The control unit 813 controls the overall operation of the femto Node B, and controls particularly the femto Node B to perform an operation converting each of alternative multicast data packets and alternative broadcast data packets received from UEs to multicast data packets and broadcast data packets. The operation converting each of the alternative multicast data packets and the alternative broadcast data packets received from the UEs to the multicast data packets and the broadcast data packets has been performed in the manner described before with reference to FIG. 7.

The reception unit 811 receives various messages and data packets from UEs, etc. under a control of the control unit 813. The storage unit 815 stores a variety of information such as received alternative multicast data packets and alternative broadcast data packets. The transmission unit 817 transmits various messages, multicast data packets and broadcast data packets to the UEs under a control of the control unit 813.

While the reception unit 811, the control unit 813, the storage unit 815 and the transmission unit 817 are shown in FIG. 8 as separate units, it is to be understood that this is for merely convenience of description. In other words, reception unit 811, the control unit 813, the storage unit 815 and the transmission unit 817 may be incorporated into a single unit.

FIG. 9 is a block diagram schematically illustrating an internal structure of an UE in a WCDMA communication system according to an embodiment of the present invention.

Referring to FIG. 9, an UE includes a reception unit 911, a control unit 913, a storage unit 915, and a transmission unit 917. The control unit 913 controls the overall operation of the UE, and controls particularly the UE to perform an operation converting each of occurred multicast data packets and broadcast data packets to alternative multicast data packets and alternative broadcast data packets. The operation converting each of the occurred multicast data packets and the broadcast data packets to the alternative multicast data packets and the alternative broadcast data packets has been performed in the manner described before with reference to FIG. 6.

The reception unit 911 receives various messages and data packets from a femto Node B, etc. under a control of the control unit 913. The storage unit 915 stores a variety of information such as received multicast data packets and broadcast data packets. The transmission unit 917 transmits various messages, alternative multicast data packets and alternative broadcast data packets to the femto Node B under a control of the control unit 913.

While the reception unit 911, the control unit 913, the storage unit 915 and the transmission unit 917 are shown in FIG. 9 as separate units, it is to be understood that this is for merely convenience of description. In other words, reception unit 911, the control unit 913, the storage unit 915 and the transmission unit 917 may be incorporated into a single unit.

In a WCDMA communication system using an LIPA scheme, if a femto Node B provides a multicast/broadcast service as described in exemplary embodiments of the invention, the same multicast/broadcast service as described in exemplary embodiments of the invention may be provided to UEs which access to a local network through the femto Node B.

As is apparent from the foregoing description, exemplary embodiments of the present invention enable providing a multicast/broadcast service in a mobile communication system, especially in a mobile communication system using a femto Node B(s).

In addition, exemplary embodiments of the present invention enable providing a multicast/broadcast service to make it possible to transmit uplink multicast/broadcast data packets in a mobile communication system.

Further, exemplary embodiments of the present invention enable providing a multicast/broadcast service in a mobile communication system supporting a LIPA scheme.

Besides, exemplary embodiments of the present invention enable providing a multicast/broadcast service without a change in protocols in a mobile communication system including a femto Node B(s).

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for providing a multicast/broadcast service by an Internet Protocol (IP) terminal in a mobile communication system, the method comprising the steps of:
upon detecting an occurrence of a multicast data packet, converting the multicast data packet to an alternative multicast data packet, and transmitting the alternative multicast data packet to a femto Node B; and
upon detecting an occurrence of a broadcast data packet, converting the broadcast data packet to an alternative broadcast data packet, and transmitting the alternative broadcast data packet to the femto Node B.

2. The method as claimed in claim 1, wherein the alternative multicast data packet includes a protocol type field, a source IP address field, and a destination IP address field, and
wherein a field value of the protocol type field is set as an alternative multicast type indicating that a corresponding packet is an alternative multicast data packet, a field value of the source IP address field is set as an IP address of the IP terminal, and a field value of the destination IP address field is set as an unicast IP address.

3. The method as claimed in claim 1, wherein the alternative broadcast data packet includes a protocol type field, a source IP address field, and a destination IP address field, and
wherein a field value of the protocol type field is set as an alternative broadcast type indicating that a corresponding packet is an alternative broadcast data packet, a field value of the source IP address field is set as an IP address of the IP terminal, and a field value of the destination IP address field is set as an unicast IP address.

4. The method as claimed in claim 1, wherein the mobile communication system supports a Local network IP Access (LIPA) scheme.

5. A method for providing a multicast/broadcast service by a femto Node B in a mobile communication system, the method comprising the steps of:
upon receiving an alternative multicast data packet from an Internet Protocol (IP) terminal, converting the alternative multicast data packet to a multicast data packet, and transmitting the multicast data packet to IP terminals included in a corresponding multicast group; and
upon receiving an alternative broadcast data packet from the IP terminal, converting the alternative broadcast data packet to a broadcast data packet, and transmitting the broadcast data packet to all of IP terminals connected to the femto Node B.

6. The method as claimed in claim 5, wherein the alternative multicast data packet includes a protocol type field, a source IP address field, and a destination IP address field, and
wherein a field value of the protocol type field is set as an alternative multicast type indicating that a corresponding packet is an alternative multicast data packet, a field value of the source IP address field is set as an IP address of the IP terminal, and a field value of the destination IP address field is set as an unicast IP address.

7. The method as claimed in claim 5, wherein the alternative broadcast data packet includes a protocol type field, a source IP address field, and a destination IP address field, and
wherein a field value of the protocol type field is set as an alternative broadcast type indicating that a corresponding packet is an alternative broadcast data packet, a field value of the source IP address field is set as an IP address of the IP terminal, and a field value of the destination IP address field is set as an unicast IP address.

8. The method as claimed in claim 5, wherein the multicast data packet includes a protocol type field, a source IP address field, and a destination IP address field, and
wherein a field value of the protocol type field is set as a multicast type indicating that a corresponding packet is a multicast data packet, a field value of the source IP address field is set as an IP address of the IP terminal, and a field value of the destination IP address field is set as a multicast IP address.

9. The method as claimed in claim 5, wherein the broadcast data packet includes a protocol type field, a source IP address field, and a destination IP address field, and
wherein a field value of the protocol type field is set as a broadcast type indicating that a corresponding packet is a broadcast data packet, a field value of the source IP address field is set as an IP address of the IP terminal, and a field value of the destination IP address field is set as a broadcast IP address.

10. The method as claimed in claim 5, wherein the mobile communication system supports a Local network IP Access (LIPA) scheme.

11. An Internet Protocol (IP) terminal in a mobile communication system, the IP terminal comprising:
a control unit for converting a multicast data packet to an alternative multicast data packet upon detecting an occurrence of the multicast data packet, and converting a broadcast data packet to an alternative broadcast data packet upon detecting an occurrence of the broadcast data packet; and
a transmission unit for transmitting the alternative multicast data packet to a femto Node B and transmitting the alternative broadcast data packet to the femto Node B.

12. The IP terminal as claimed in claim 11, wherein the alternative multicast data packet includes a protocol type field, a source IP address field, and a destination IP address field, and
wherein a field value of the protocol type field is set as an alternative multicast type indicating that a corresponding packet is an alternative multicast data packet, a field value of the source IP address field is set as an IP address of the IP terminal, and a field value of the destination IP address field is set as an unicast IP address.

13. The IP terminal as claimed in claim 11, wherein the alternative broadcast data packet includes a protocol type field, a source IP address field, and a destination IP address field, and
wherein a field value of the protocol type field is set as an alternative broadcast type indicating that a corresponding packet is an alternative broadcast data packet, a field value of the source IP address field is set as an IP address of the IP terminal, and a field value of the destination IP address field is set as an unicast IP address.

14. The IP terminal as claimed in claim 1, wherein the mobile communication system supports a Local network IP Access (LIPA) scheme.

15. A femto Node B in a mobile communication system, the femto Node B comprising:
a reception unit for receiving an alternative multicast data packet from an Internet Protocol (IP) terminal, and receiving an alternative broadcast data packet from the IP terminal;
a control unit for converting the alternative multicast data packet to a multicast data packet, and converting the alternative broadcast data packet to a broadcast data packet; and
a transmission unit for transmitting the multicast data packet to IP terminals included in a corresponding multicast group, and transmitting the broadcast data packet to all of IP terminals connected to the femto Node B.

16. The femto Node B as claimed in claim 15, wherein the alternative multicast data packet includes a protocol type field, a source IP address field, and a destination IP address field, and
wherein a field value of the protocol type field is set as an alternative multicast type indicating that a corresponding packet is an alternative multicast data packet, a field value of the source IP address field is set as an IP address of the IP terminal, and a field value of the destination IP address field is set as an unicast IP address.

17. The femto Node B as claimed in claim 15, wherein the alternative broadcast data packet includes a protocol type field, a source IP address field, and a destination IP address field, and
wherein a field value of the protocol type field is set as an alternative broadcast type indicating that a corresponding packet is an alternative broadcast data packet, a field value of the source IP address field is set as an IP address of the IP terminal, and a field value of the destination IP address field is set as an unicast IP address.

18. The femto Node B as claimed in claim 15, wherein the multicast data packet includes a protocol type field, a source IP address field, and a destination IP address field, and
wherein a field value of the protocol type field is set as a multicast type indicating that a corresponding packet is a multicast data packet, a field value of the source IP address field is set as an IP address of the IP terminal, and a field value of the destination IP address field is set as a multicast IP address.

19. The femto Node B as claimed in claim 15, wherein the broadcast data packet includes a protocol type field, a source IP address field, and a destination IP address field, and
wherein a field value of the protocol type field is set as a broadcast type indicating that a corresponding packet is a broadcast data packet, a field value of the source IP address field is set as an IP address of the IP terminal, and a field value of the destination IP address field is set as a broadcast IP address.

20. The femto Node B as claimed in claim 15, wherein the mobile communication system supports a Local network IP Access (LIPA) scheme.
